(19) United States
(12) Patent Application Publication
(10) Pub. No.: US 2008/0218131 A1
(43) Pub. Date: Sep. 11, 2008

(54) No emission portable generator

(76) Inventors: Teodoro Rivera, Mims, FL (US); Carlos A. Rivera, Mims, FL (US); Jose R. Rivera, Mims, FL (US); Marco A. Rivera, Mims, FL (US)

Correspondence Address: JAMES RAY & ASSOCIATES, 2640 PITCAIRN ROAD, MONROEVILLE, PA, 15146, US

(21) Appl. No.: 12/072,550

(22) Filed: Feb. 27, 2008

Related U.S. Application Data
(60) Provisional application No. 60/903,602, filed on Feb. 27, 2007.

(51) Int. Cl. H02P 11/06; H02K 5/00

(52) U.S. Cl. 322/1; 322/39

(57) ABSTRACT

A generator without emissions that portably temporarily and quietly is capable of producing electrical power for household appliances in the event of a blackout. The generator has a power source such as a battery and on/off switch operably connected to an electrical motor. The motor is connected to an alternator that is operably connected to at least one outlet. The generator is contained in a housing that may be moved by the user.

### CROSS REFERENCE TO RELATED APPLICATION

This patent application is related to and claims priority from U.S. Provisional Patent Application Ser. No. 60/903,602 filed Feb. 27, 2007.

### FIELD OF THE INVENTION

The present invention relates, in general, to power generator and, more particularly, this invention relates to no emission emergency power generation for household appliances.

### BACKGROUND OF THE INVENTION

Prior to the conception and development of the present invention, as is generally well known in the prior art, portable power generators and uninterrupted power supplies. Most portable power supplies are driven by internal combustion motors that require the device to be operated outdoors because of then noise and the exhaust hazard. The uninterrupted power supplies are designed to provide short term power to computers and use a solid state circuit to supply alternating current.

### SUMMARY OF THE INVENTION

The present invention provides a power supply operably connected to an electric motor. The motor drives an alternator that is operably connected to at least one outlet. An on/off switch is operably connected between the power source and the electric motor. The use of an alternator is technologically simple and therefore easier to repair and maintain than a solid state circuit.

The present invention also optionally powers a battery charger for small sized household batteries used in an emergency such as sizes “D”, “C”, “AA” and “AAA”.

The apparatus which is referred to herein as a generator is contained in a portable housing so that it can be moved to an appropriate location. The housing has a predetermined shape. The presently preferred shape is generally rectilinear. The housing has a top surface, four side surfaces and a bottom surface. The housing has at least one access panel preferably in at least one of the side surfaces. The at least one outlet and on/off switches are located on at least one side surface. The apparatus preferably has a vent in at least one of the side panels.

The electric motor can drive the alternator directly or by use of a chain drive.

### OBJECTS OF THE INVENTION

It is, therefore, one of the primary objects of the present invention to provide a convenient no emission portable temporary generator for emergencies.

Another object of the present invention is to provide a generator that is technologically simple to provide for simpler maintenance.

Still another object of the present invention is to provide a generator that is quiet and that can be operated indoors

Yet another object of the present invention is to provide a convenient battery charger for small house hold batteries in an emergency.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective view of the device.

FIG. 2 is a perspective view the obverse direction of the perspective view of FIG. 1.

FIG. 3 is a schematic diagram.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

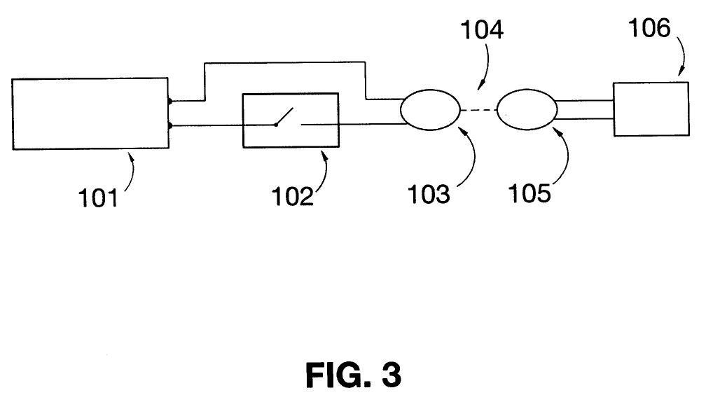

Reference is now made, more particularly, to FIG. 3. A direct current power source 101 is provided. Preferably the power source is at least one battery. The battery is preferably one of a lead storage battery, lithium ion battery, or nickel cadmium. The power source 101 may be a plurality of batteries.

The power source 101 is operably connected to an on off switch 102. The switch is connected to an electric motor 103.

The electric motor is connected to a mechanical drive means 104 to alternator 105. The mechanical drive means is preferably one of direct drive, belt drive or chain drive.

Alternator 105 is operably connected to at least one outlet 106.

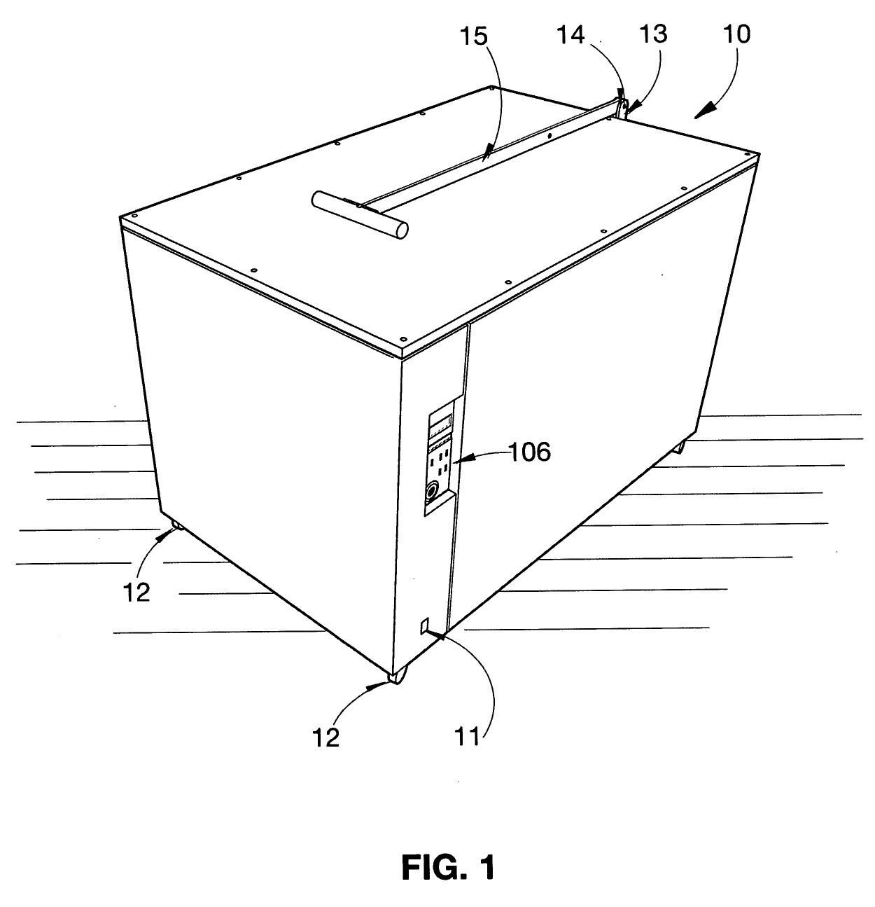

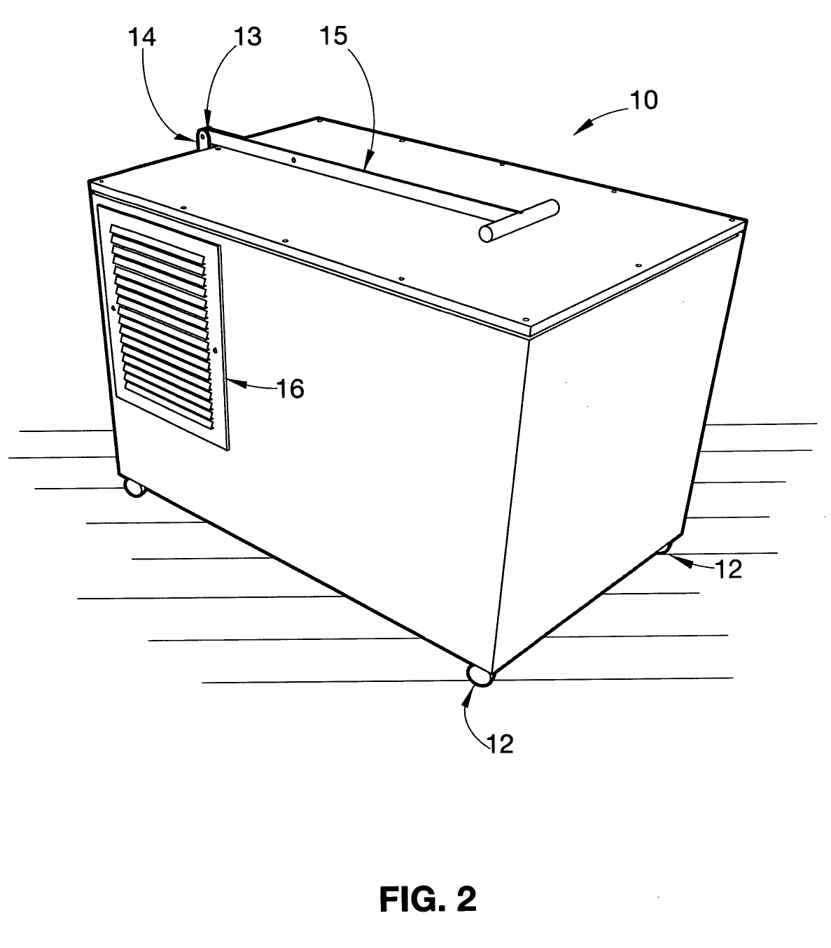

The generator is contained within housing 10 as shown on FIG. 1 and FIG. 2. The housing has a predetermine shape, preferably generally rectilinear with a generally rectilinear top surface, four generally rectilinear side surface and a generally rectilinear bottom surface.

The switch operating surface 11 of switch 102 is located in one of the side surfaces. Outlets 106 are also located in one of the side surfaces of housing 10. In the preferred embodiment the switch operating surface 11 and outlets 106 are located in the same side surface of housing 10.

A vent 16 is located in one of the side surfaces of housing 10.

Casters are attached to the bottom surface of housing 10. At least 3 and preferably, four casters are attached. Preferably, the casters are generally adjacent to the corners of the bottom surface of housing 10.

A bracket 13 (partially shown) is attached to housing 10. Preferably, bracket 13 is attached to a side surface of housing 10. The bracket has a pivot 14. A handle 15 is pivotably attaché to bracket 13 permitting a towing handle to be folded onto the top surface of housing 10 for storage when not in use. In operation the handle is pivoted so that the user can pull the housing to desired location.

Optionally, a battery charger (not shown) is included operably connected to the batter to provide charging for household batteries.

In operation the device provides temporary emergency power for household appliances during a power outage. The present device does not emit exhaust and is quiet in operation.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

We claim:

1. An electrical generator comprising:
a direct current power source;
an electric motor operably connected to said battery;
an alternator connected to said electric motor;
at least one outlet operably connected to said alternator; and,
a switch operably connected between said battery and said electric motor.

2. A claim according to claim 1 wherein said direct current power source is at least one battery.

3. A claim according to claim 2 wherein said at least one battery is one of lead storage, lithium-ion and nickel-cadmium.

4. A claim according to claim 1 wherein there are 3 outlets.

5. A claim according to claim 1 wherein such generator is contained in a housing with a predetermined shape.

6. A claim according to claim 5 wherein said housing has a generally rectilinear shape with a generally rectangular top surface, generally rectangular four side surfaces and a generally rectangular bottom surface;

7. A claim according to claim 6 wherein at least one of said side surfaces having an access panel for said power source to enable the user to replace or charge said power source.

8. A claim according to claim 6 wherein said at least one outlet is position at a predetermined position in one of said side surfaces.

9. A claim according to claim 6 wherein at least one vent is located a predetermined location within said at least one side surface.

10. A claim according to claim 6 wherein at least 3 casters are attached to said bottom surface of said housing to permit the user to easily move the generator.

11. A claim according to claim 10 including four casters, said casters are positioned generally adjacent to the corners of said bottom rectangular surface of said housing.

12. A claim according to claim 10 further including at least one bracket and at least one handle; each of said at least one bracket is fixedly attached to said housing; each of said at least one bracket includes a pivot; and said at least one handle is pivotably attached to said pivot in said bracket.

13. A claim according to claim 1 wherein a battery charger is operably connected to said power source.

14. An electrical generator with a direct current power source comprising:
an electric motor operably connected to such power source;
an alternator connected to said electric motor;
at least one outlet operably connected to said alternator; and,
a switch operably connected between said battery and said electric motor.

15. A claim according to claim 14 wherein such generator is contained in a housing with a predetermined shape.

16. A claim according to claim 15 wherein said housing has a generally rectilinear shape with a generally rectangular top surface, generally rectangular four side surfaces and a generally rectangular bottom surface;

17. A claim according to claim 16 wherein at least one of said side surfaces having an access panel for such power source to enable the user to replace or charge said power source.

18. A claim according to claim 16 wherein said at least one outlet is position at a predetermined position in one of said side surfaces.

19. A claim according to claim 16 wherein at least one vent is located a predetermined location within said at least one side surface.

20. A claim according to claim 16 wherein at least 3 casters are attached to said bottom surface of said housing to permit the user to easily move the generator.
